(19) United States
(12) Patent Application Publication
(10) Pub. No.: US 2012/0113634 A1
(43) Pub. Date: May 10, 2012

(54) LED LAMP ASSEMBLY

(76) Inventor: JIA-SHING WONG, Kotakinabalu (MY)

(21) Appl. No.: 13/095,869

(22) Filed: Apr. 28, 2011

(30) Foreign Application Priority Data
Nov. 8, 2010 (TW) 099221597

(51) Int. Cl. F21V 11/00; F21S 4/00

(52) U.S. Cl. 362/235; 362/249.02

(57) ABSTRACT

An LED lamp assembly contains a number of light source modules, a front cover, a back cover, two side covers, a power supply, a transparent top cover, and at least a bottom cover. Each light source module contains a circuit board and a heat dissipation element. The circuit board has a number of LEDs and secondary optical elements. The heat dissipation elements have connection elements so that a number of heat dissipation elements could be slide-joined together side by side, and front and back covers could also slide-joined to the dissipation elements. Each heat dissipation element has a number of fins and each fin has a number of grooves so as to increase the heat dissipation area of the LED lamp assembly.

### (a) TECHNICAL FIELD OF THE INVENTION

The present invention is generally related to LED lamps, and more particularly to a LED lamp having enhanced heat dissipation capability and simplified assembly.

### (b) DESCRIPTION OF THE PRIOR ART

A conventional LED lamp assembly is usually designed in accordance with a traditional lamp specification such as those of 7 W, 60 W, 120 W power. Yet, with the technology advancement, an LED lamp assembly is capable of achieving comparable brightness with substantially reduced power consumption. Especially in recent year where environment protection is n universal requirement, how to achieve reasonable brightness with at least power consumption and manufacturing complexity as possible is a major concern for lamp manufacturers.

### SUMMARY OF THE INVENTION

A novel LED lamp assembly is provided herein. The LED lamp assembly contains two light source modules, a front cover, a back cover, two side covers, a power supply, a transparent top cover, and at least a bottom cover. Each light source module contains a circuit board and a heat dissipation element. The circuit board has a number of LEDs and secondary optical elements. End-to-end along front and back sides of the heat dissipation element, a first connection element and a second connection element are configured respectively. As such, a number of heat dissipation elements could be slide-joined together side by side, and front and back covers could also slide-joined to the dissipation elements. Each heat dissipation element has a number of fins and each fin has a number of grooves so as to increase the heat dissipation area of the LED lamp assembly.

In alternative embodiments, the LED lamp assembly contains two light source modules, a front cover, a back cover, two side covers, a power supply, a transparent top cover, and at least a bottom cover. Each light source module contains a circuit board and a heat dissipation element. The circuit board has a number of LEDs and secondary optical elements. The LEDs are arraigned in units of one, two, or four rows. Multiple light source modules therefore could be put together to fulfill an application's specific brightness requirement.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective break-down diagram of an LED lamp assembly according to an embodiment of the present invention.

FIG. 1A is an enlarged view of a portion of FIG. 1.

FIG. 2 is a perspective diagram showing the LED lamp assembly's light source modules of FIG. 1.

FIG. 2A is an enlarged view of a portion of FIG. 2.

FIG. 2B is an enlarged view of a portion of FIG. 2.

FIG. 3 is a perspective diagram showing a light source modules of the LED lamp assembly according to an alternative embodiment.

FIG. 3A is an enlarged view of a portion of FIG. 3.

FIG. 4 is a perspective diagram showing the scenario of joining the light source modules of FIG. 1 together.

FIG. 5 is a perspective diagram showing the scenario of joining a front cover and a back cover with the light source modules of FIG. 4.

FIG. 5A is an enlarged view of a portion of FIG. 5.

FIGS. 6, 7, 8, and 9 are perspective diagram showing the scenarios of joining side covers and a top cover to the light source modules of FIG. 5.

FIG. 10 is a perspective diagram showing the scenario of joining a power supply to a base plate.

FIG. 11 is a perspective diagram showing the scenario of joining the power supply and base plate of FIG. 10 with the LED lamp assembly of FIG. 9.

FIGS. 12, 13, and 14 are perspective diagrams showing the scenarios of joining bottom covers and an L-shaped cover to the LED lamp assembly of FIG. 11.

FIG. 13A is an enlarged view of a portion of FIG. 13.

FIG. 15 is a perspective diagram showing the LED lamp assembly of FIG. 1 after its assembly.

FIG. 16 is a cross-sectional diagram showing the LED lamp assembly of FIG. 1 after its assembly.

FIG. 17 is a schematic diagram showing an application of the LED lamp assemblies in in-door lighting.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

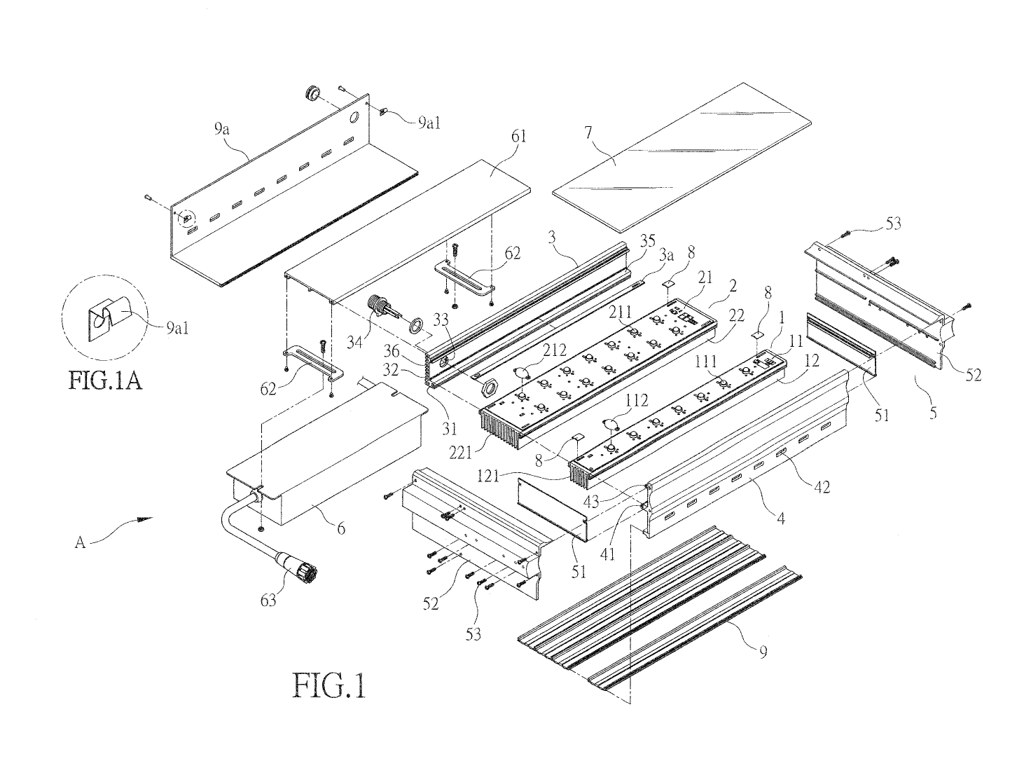

As shown in FIGS. 1 and 1A, a LED lamp assembly A according to an embodiment of the present invention contains a first light source module 1, a second light source module 2, a front cover 3, a back cover 4, two side covers 5, a power supply 6, a transparent top cover 7, and one or more bottom covers 9.

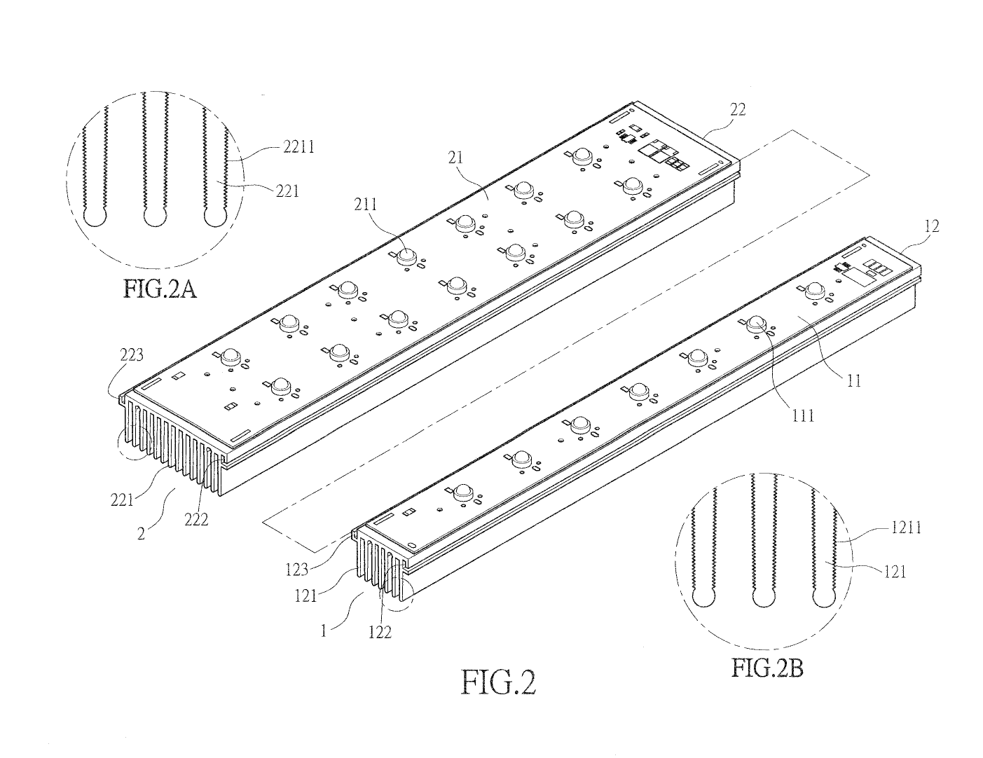

As further shown in FIGS. 2, 2A and 2B, the first light source module 1 contains a circuit board 11 and a heat dissipation element 12. The circuit board 11 has a number of LEDs 111 arranged in unit of rows. Each LED 111 is configured with a secondary optical element (e.g., a lens) 112 which focuses the light from the corresponding LED 111 towards a designated area. The heat dissipation element 12 has a number of fins 121 extended downward and each fin 121 has a number of grooves 1211 so as to increase the heat dissipation area. Along front and back sides of the heat dissipation element 12, a first connection element 122 having an indentation with L-shaped cross section and a second connection element 123 having L-shaped cross section are configured respectively. As such, a number of heat dissipation elements 12 could be slide-joined together side by side.

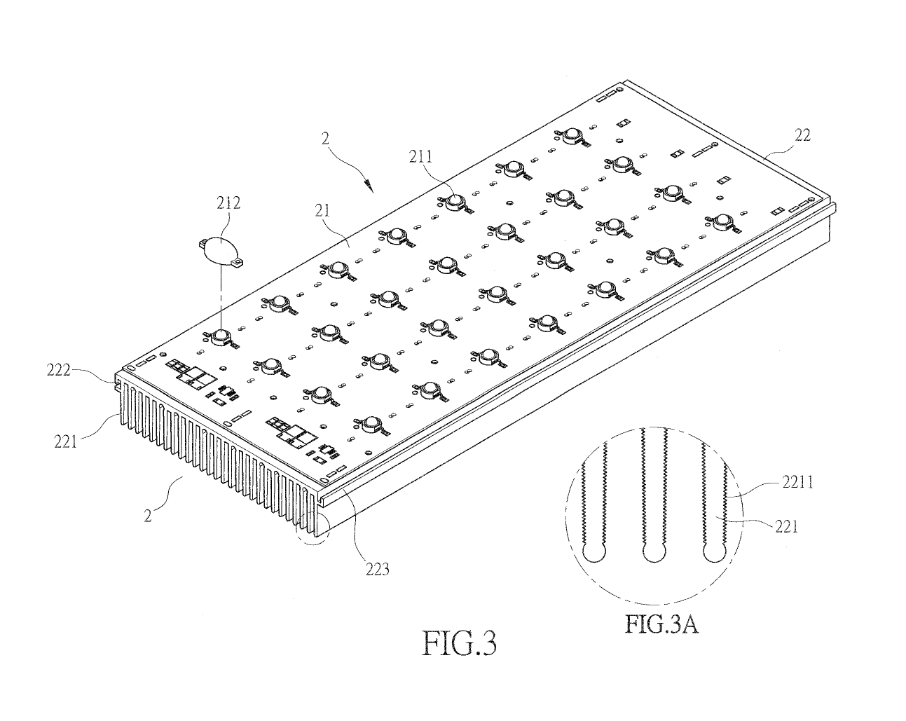

The second light source module 2 contains a circuit board 21 and a heat dissipation element 22. The circuit board 21 has a number of LEDs 211 arranged in unit of two rows. Each LED 211 is configured with a secondary optical element (e.g., a lens) 212 which focuses the light from the corresponding LED 211 towards a designated area. The heat dissipation element 22 has a number of fins 221 extended downward and each fin 221 has a number of grooves 2211 so as to increase the heat dissipation area. End-to-end along front and back sides of the heat dissipation element 22, a first connection element 222 having an indentation with L-shaped cross section and a second connection element 223 having L-shaped cross section are configured respectively. As such, a number of heat dissipation elements 22 could be slide-joined together side by side. As shown in FIGS. 3 and 3A, the second light source module 2 could also have the LEDs 211 arranged in unit of two rows. Depending on the brightness requirement, the light source modules could be assembled in the factory in advance.

As shown in FIGS. 1 and 1A, the front cover 3 has a third connection element 31 with an indentation of L-shaped cross section configured end-to-end along a bottom edge on an inner side so as to engage the second connection element 223 of the second light source module 2. A number of fins 32 for heat dissipation are configured on a front surface of the front cover 3. Each fin 32 has a number of grooves 321 so as to increase the heat dissipation area. Adjacent to an end of the front cover 3, a through hole 33 is provided, allowing the configuration of an anti-water socket 34. A support seat 35 is on top of the third connection element 31, allowing the configuration of a power connection plate 3a. A fourth connection element 36 having L-shaped cross-section is configured end-to-end along a top edge on the inner side for the position of the top cover 7.

The back cover 4 has a fifth connection element 41 with L-shaped cross section end-to-end on an inner side along a middle section for engaging the first connection element 122 of the first light source module 1. Also along the middle section of the back cover 4 and beneath the fifth connection element 41, a number of heat dissipation holes 42 are provided. End-to-end along a top edge on the inner side of the back cover 4, a sixth connection element 43 having L-shaped cross-section is configured for the position of the top cover 7.

Each side cover 51 contains an inner piece 51 and an outer piece 52. Notches 511 are configured at a front top corner and a back front corner, respectively. The outer piece 52 has a longer length than that of the inner piece 51. The outer piece 52 has a number of bolt holes 521.

The power supply 6 is fixed to a base plate 61 by a number of fastening elements 62. The integrated power supply 6 and base plate 61 are positioned between the two outer pieces 52. The power supply 6 is electrically connected to the power connection plate 3a via the anti-water socket 34.

The top cover 7 is made of a transparent material and is positioned above the first and second light source modules 1 and 2.

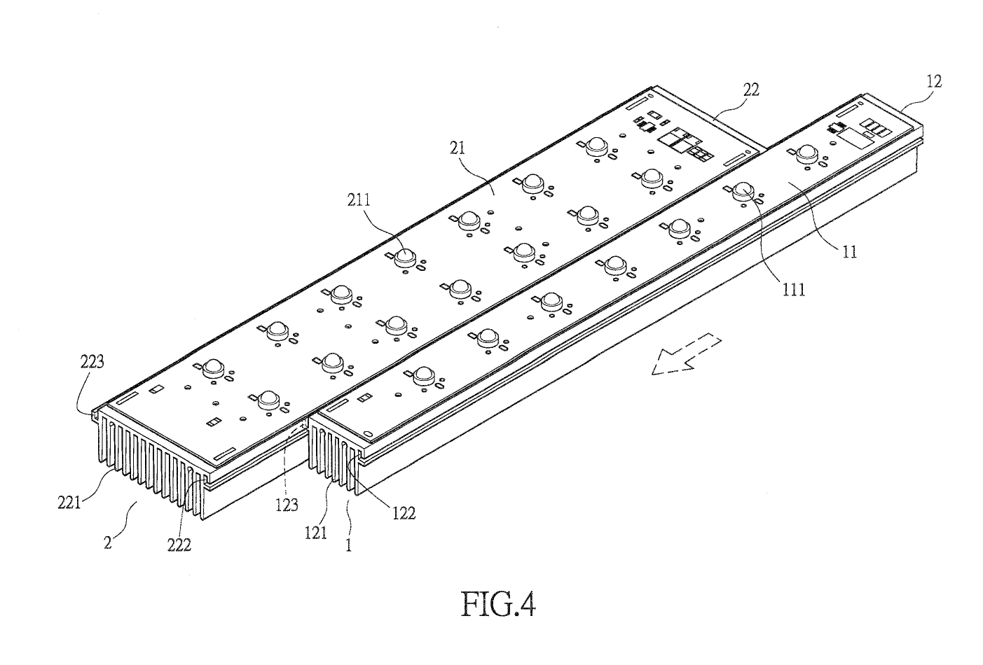

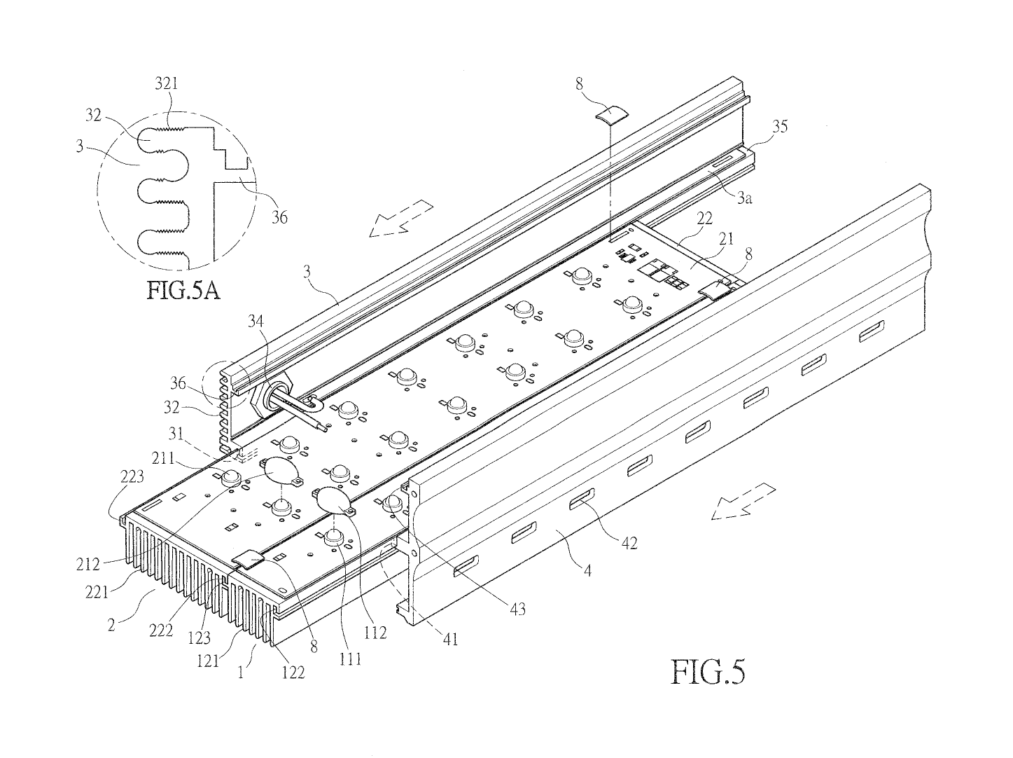

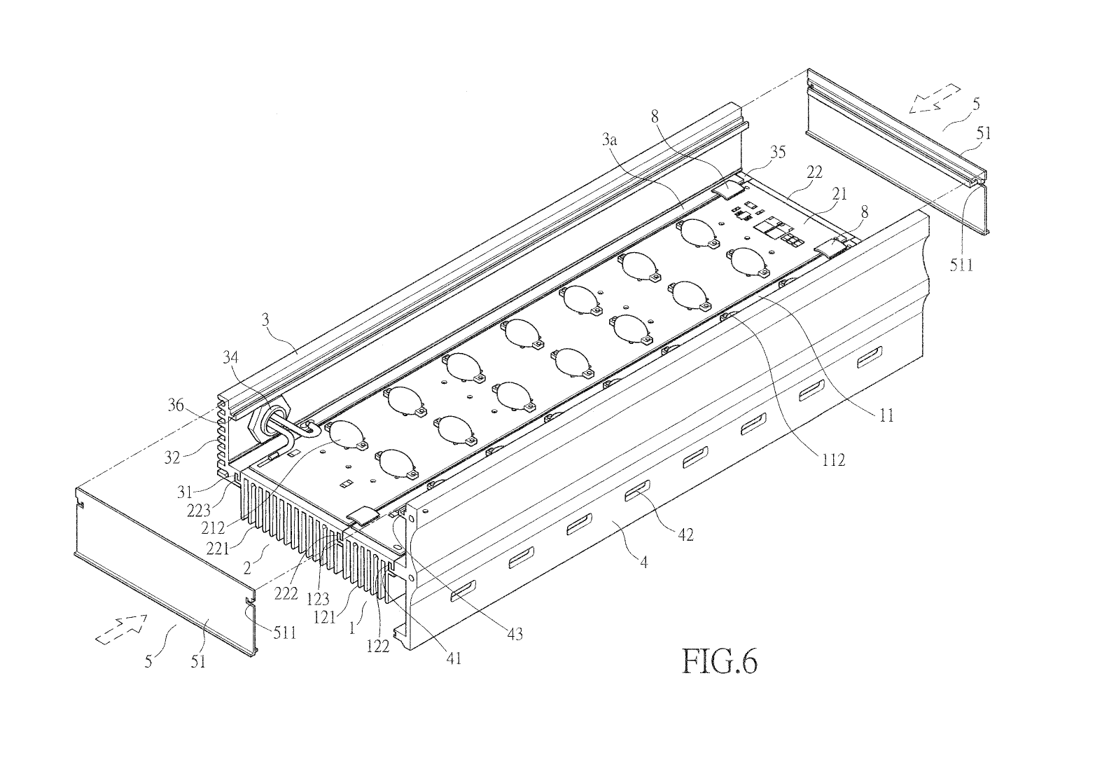

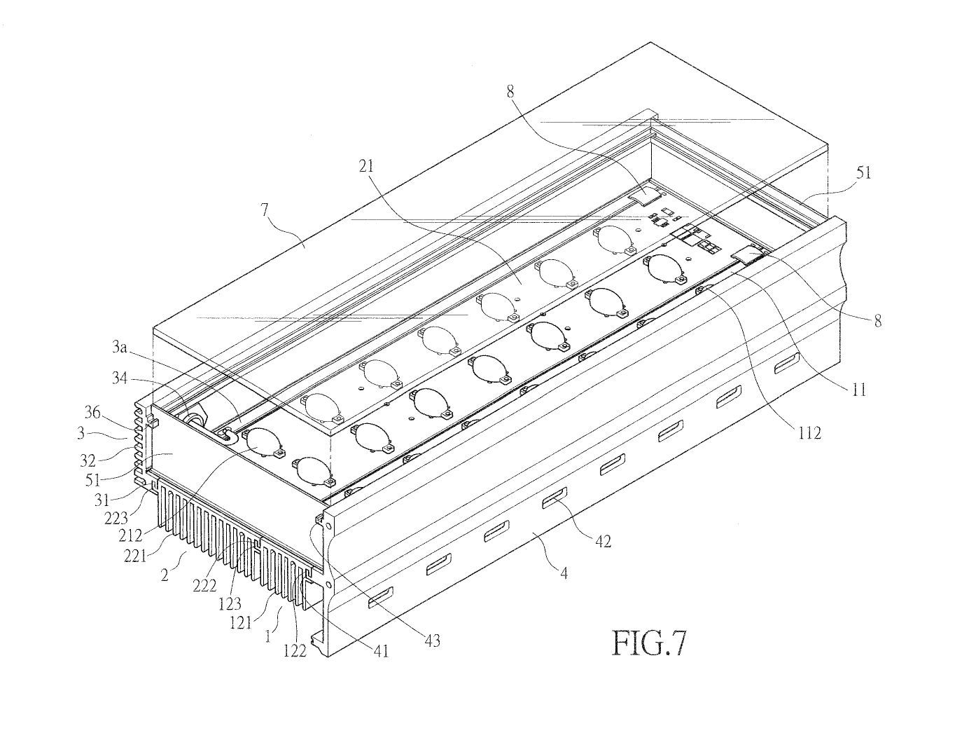

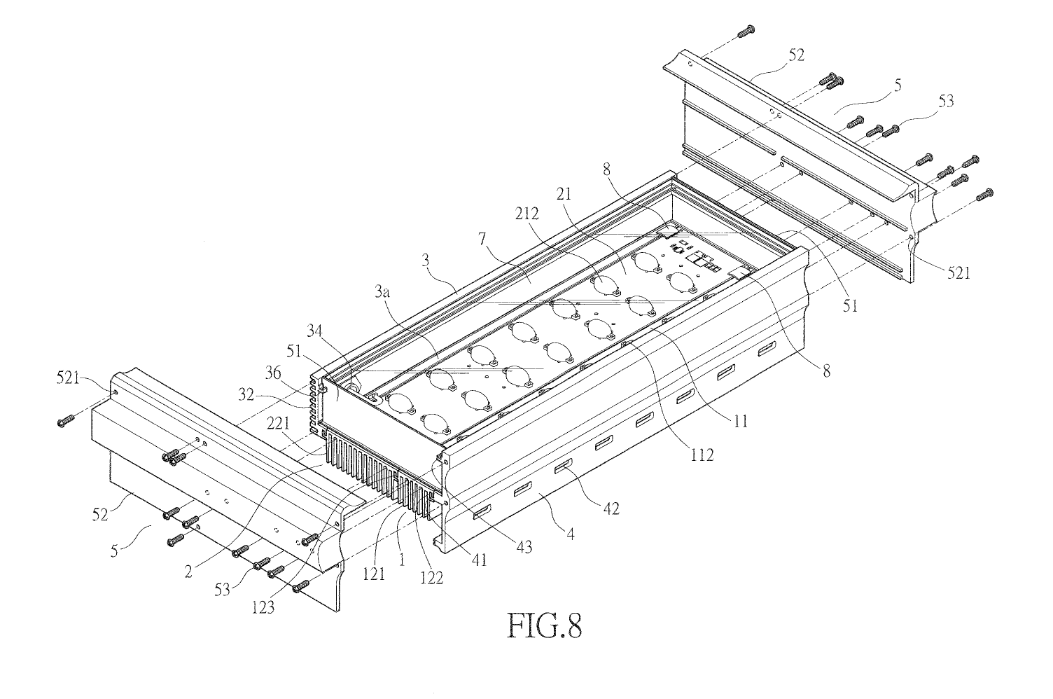

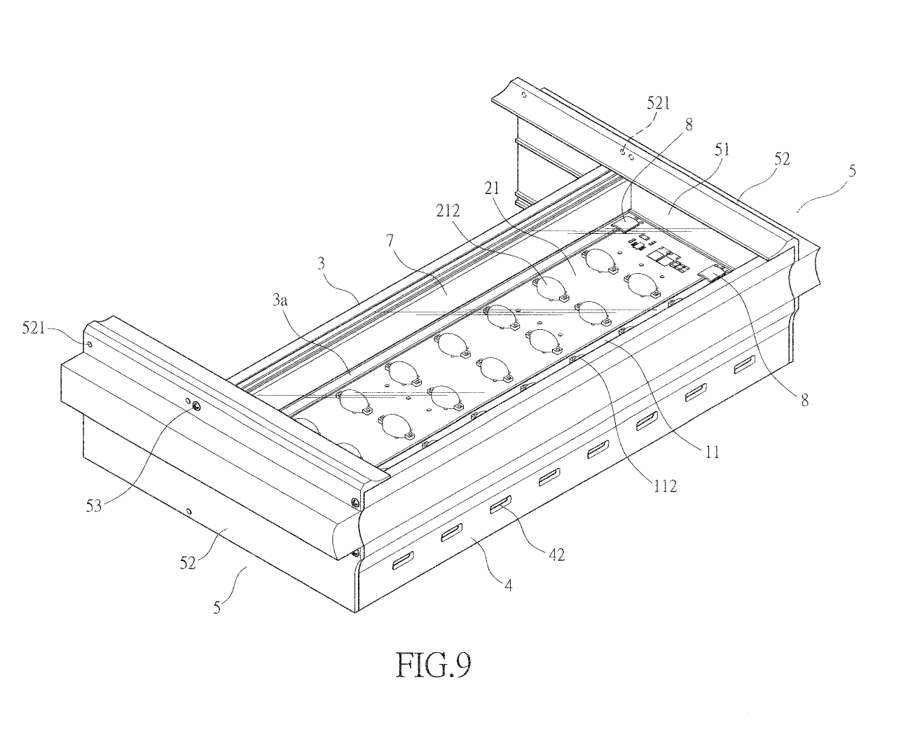

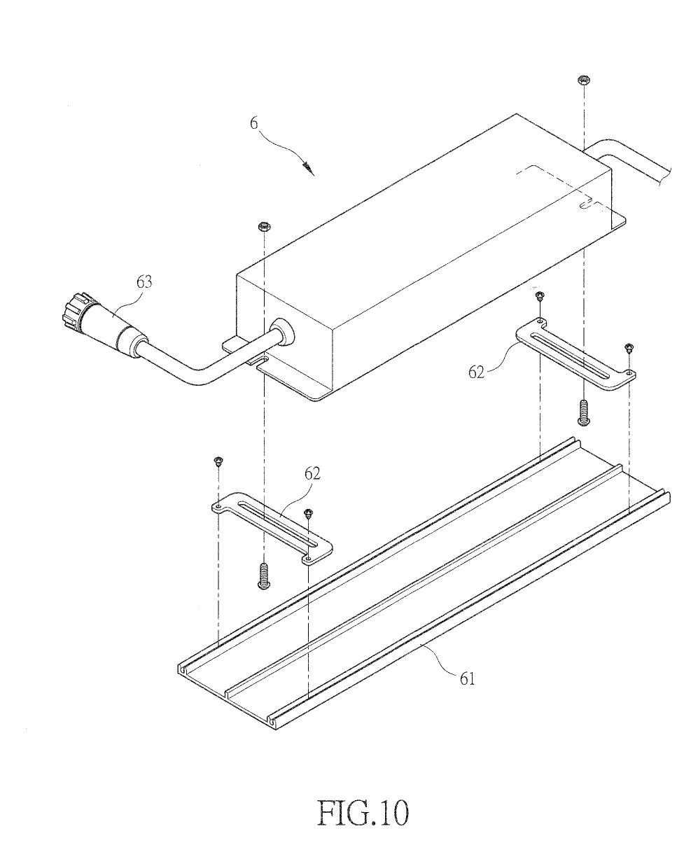

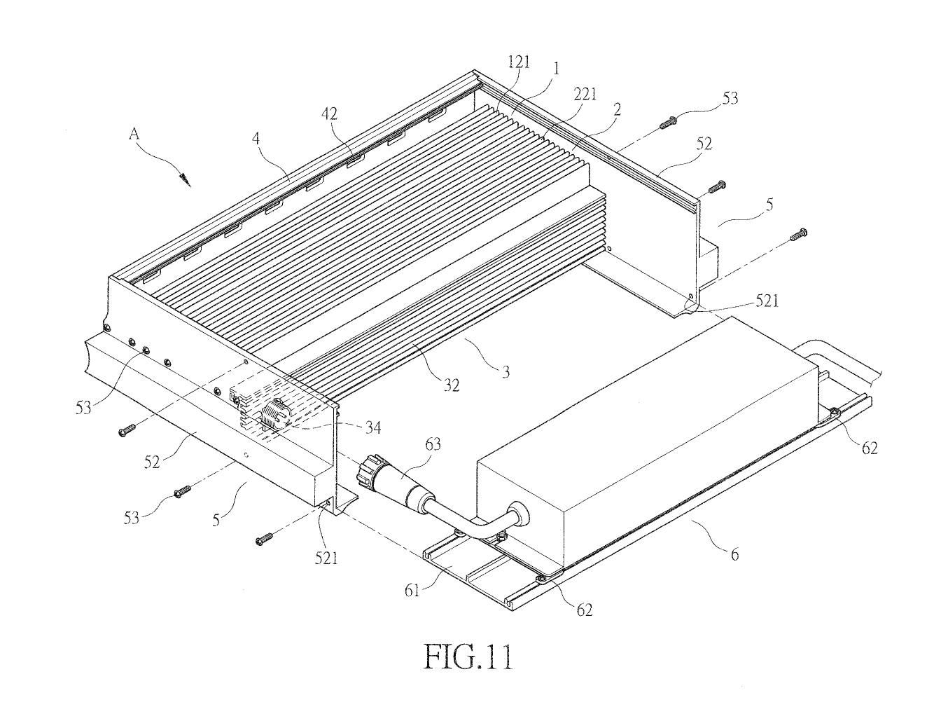

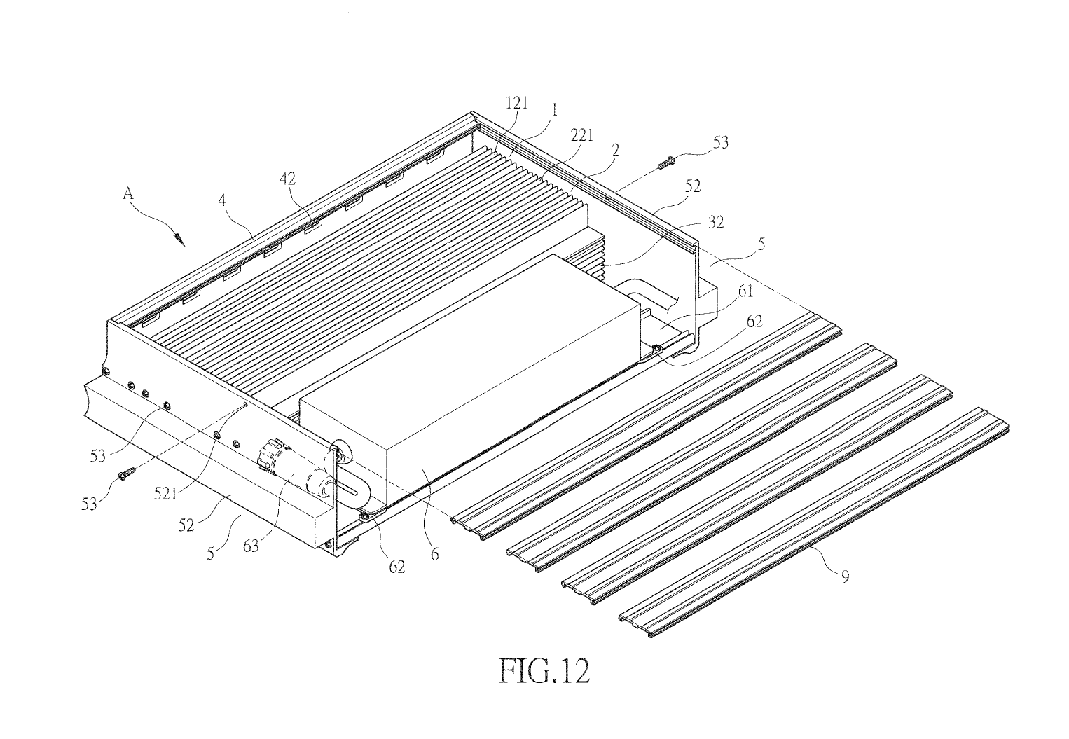

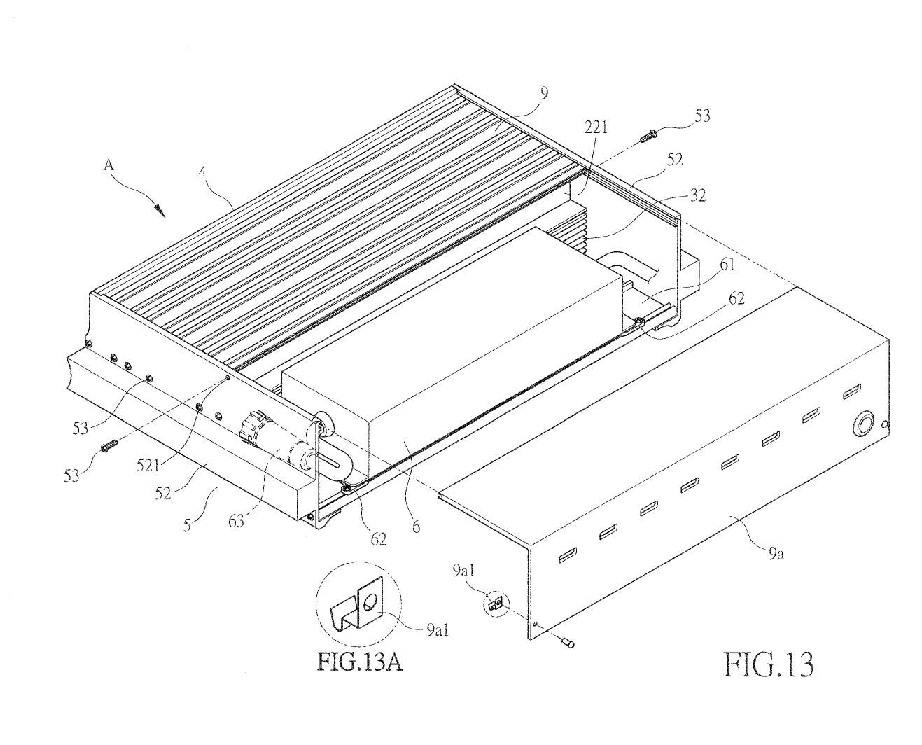

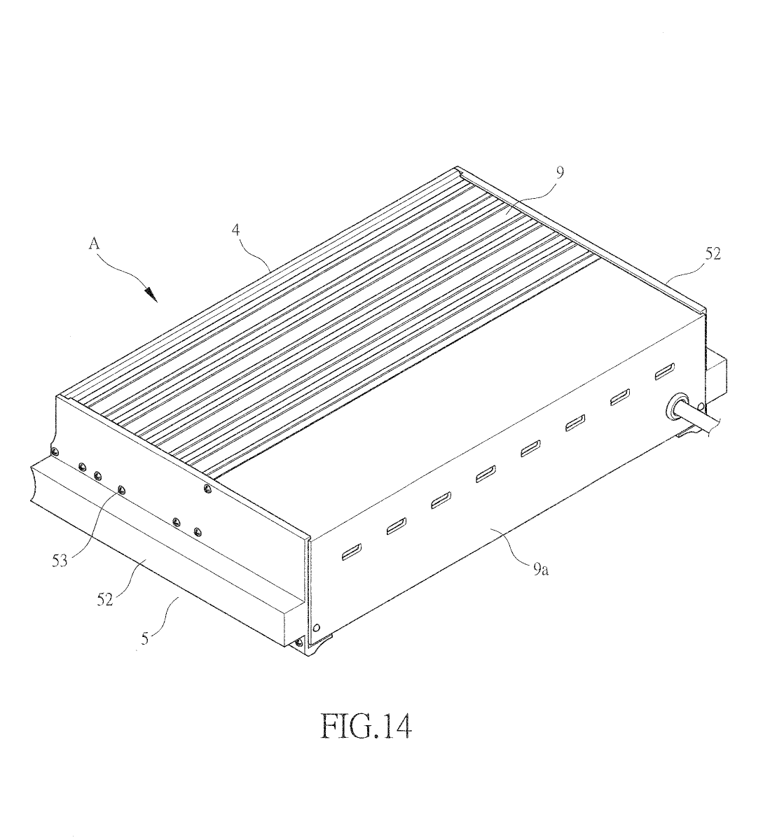

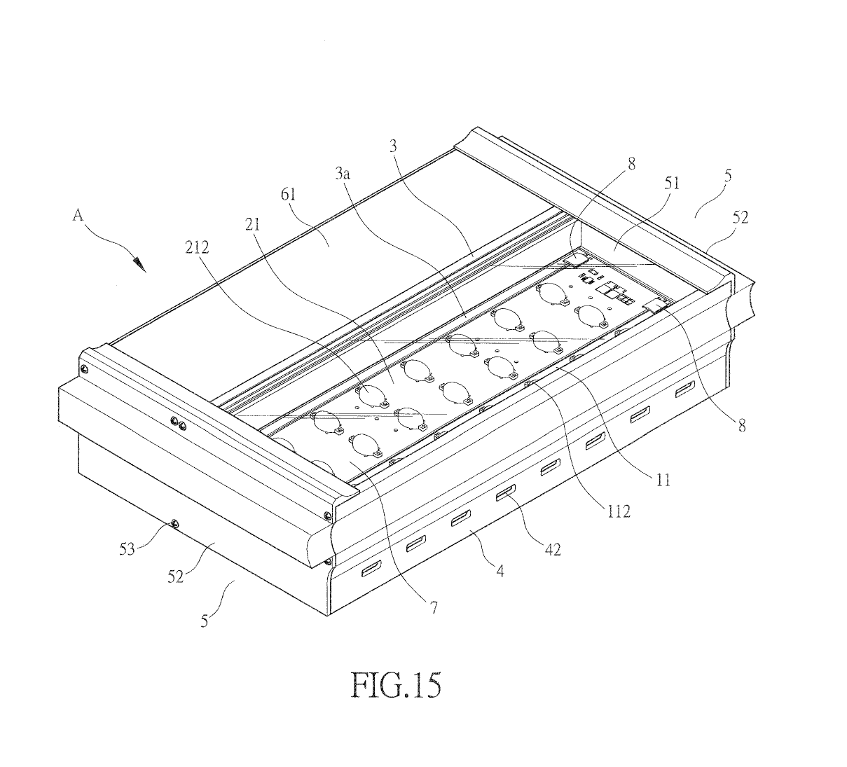

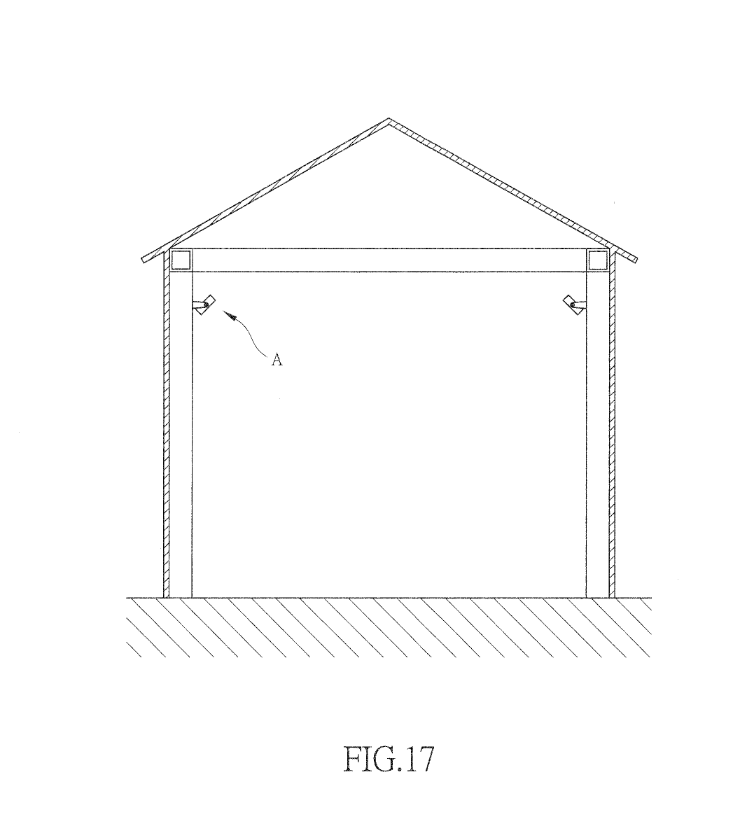

The LED lamp assembly A is put together as follows. As shown in FIGS. 4, 5 and 5A, the first and second light source modules 1 and 2 are joined side by side together by sliding the second connection element 123 of the first light source module 1 into the first connection element 222 of the second light source module 2. Then the front cover 3 is integrated by sliding the second connection element 223 of the second light source module 2 into the third connection element 31 of the front cover 3. Similarly, the back cover 4 is integrated by sliding the fifth connection element 41 of the back cover 4 into the first connection element 122 of the first light source module 1. Then, electrical connection elements 8 are configured between the power connection plate 3a and the second light source module 2, and between the second light source module 2 and the first light source module 1, so that they are series-connected electrically. As further shown in FIGS. 6, 7, 8, and 9, the two ends of the fourth connection element 36 of the front cover 3 and the sixth connection element 43 of the back cover 4 are embedded in the notches 511 of the inner pieces 51. Then, an outer piece 52 is joined to the first and second light source module 1 and 2, and the front and back covers 3 and 4 by bolts 53, as shown in FIG. 8. The top cover 7 is positioned between the front and back covers 3 and 4, and on top of the first and second light source modules 1 and 2, so that a side of the top cover 7 is against an inner piece 51 inside the outer piece 52. Then, as shown in FIG. 9, the other outer piece 52 is joined to the first and second light source module 1 and 2, and the front and back covers 3 and 4 by bolts 53. As shown in FIGS. 10, 11, 12, 13, 13A, 14 and 15, the base plate 61 beneath of the power supply 6 is joined to the outer pieces 52 by applying bolts 53 through bolt holes 521. A plug 63 of the power supply 6 is connected to the anti-water socket 34 on the front cover 3. A number of bottom covers 9 are applied to seal the light source modules 1 and 2 from beneath. An L-shaped cover 9a is joined to the LED lamp assembly A to seal the power supply 6 by engaging hooks 9a1 of the cover 9a to the base plate 61 and by applying bolts 53 through the bolt holes 521. The assembly of the LED lamp assembly A is then completed. As shown in FIG. 17, the LED lamp assembly A could be placed at an appropriate place to provide illumination.

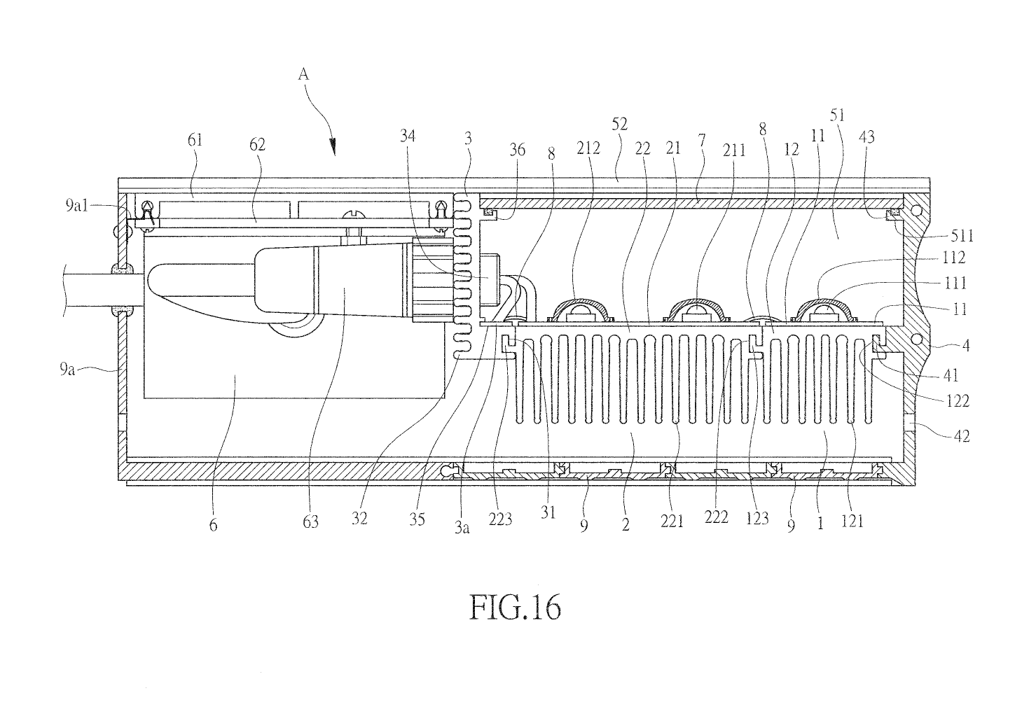

As shown in FIG. 16, the light from the LEDs 111 and 211 are focused by the secondary optical elements 112 and 212 on the circuit boards 11 and 21 to a designated coverage area so as to increase the brightness of the LED lamp assembly A.

The gist of the present invention lies in the following. The heat dissipation elements 12 and 22 have first and second connection elements 122 and 222, and 123 and 223. As such, the heat dissipation elements 12 and 22 could be joined together and further with front and back covers 3 and 3. Additionally, the heat dissipation elements 12 and 22 have a number of fins 121 and 221, each having a number of grooves 1211 and 2211 so as to increase the heat dissipation area. Moreover, the LEDs 211 on the second light source module 2 could be arranged in units of two rows or four rows. Then, depending on the brightness requirement, an appropriate number of first and second light source modules 1 and 2 could be put together conveniently and easily.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A LED lamp assembly, comprising:
at least a first light source module and a second light source module, each light source module comprising a circuit board and a heat dissipation element, each circuit board having a plurality of LEDs, and each heat dissipation element having connection elements along front and back sides of said heat dissipation element;
a front cover having a connection element for joining with a connection element of said heat dissipation element of said second light source module;
a back cover having a connection element for joining with a connection element of said heat dissipation element of said first light source module;
two side covers, each having an inner piece and an outer piece, each side cover being configured to an end of said light source modules;
a transparent top cover positioned between said front and back cover and on top of said light source modules;
a power supply on a base plate together positioned between said outer pieces; and
at least a bottom covers beneath said first and second light source modules.

2. The LED lamp assembly according to claim 1, wherein said LEDs of said first light source module are arranged in units of one row.

3. The LED lamp assembly according to claim 1, wherein each of said LEDs is configured with a secondary optical element.

4. The LED lamp assembly according to claim 1, wherein said heat dissipation elements have a plurality of fins extended downward; and each fin has a plurality of grooves so as to increase the heat dissipation area.

5. The LED lamp assembly according to claim 1, wherein said LEDs of said second light source module are arranged in units of two rows.

6. The LED lamp assembly according to claim 1, wherein said LEDs of said second light source module are arranged in units of four rows.

7. The LED lamp assembly according to claim 1, wherein a plurality of fins for heat dissipation are configured on a front surface of said front cover; each fin has a plurality of grooves so as to increase the heat dissipation area; and said back cover has a plurality of heat dissipation holes.

8. The LED lamp assembly according to claim 1, wherein a through hole is provided adjacent to an end of said front cover; and an anti-water socket is configured in said through hole.

9. The LED lamp assembly according to claim 1, wherein a support seat is on top of said third connection element of said front cover; and a power connection plate is positioned on said support seat.

10. The LED lamp assembly according to claim 9, wherein said power connection plate is electrically connected to said first and second light source modules.
